(19) United States
(12) Patent Application Publication
(10) Pub. No.: US 2017/0227060 A1
(43) Pub. Date: Aug. 10, 2017

(54) Roller Unit for Sliding-Type Tripod Constant-Velocity Joint and Sliding-Type Tripod Constant-Velocity Joint

(71) Applicant: TOYOTA JIDOSHA KABUSHIKI KAISHA, Toyota-shi (JP)

(72) Inventor: Yasuhiro MIYAMOTO, Miyoshi-shi (JP)

(73) Assignee: TOYOTA JIDOSHA KABUSHIKI KAISHA, Toyota-shi (JP)

(21) Appl. No.: 15/424,981

(22) Filed: Feb. 6, 2017

(30) Foreign Application Priority Data
Feb. 10, 2016 (JP) 2016-023713

(51) Int. Cl. F16D 3/205

(52) U.S. Cl. CPC F16D 3/2055; F16D 2003/2026

(57) ABSTRACT

A roller unit includes: an outer roller rollably provided in a corresponding one of raceway grooves of an outer member; an inner roller rotatably supported on a corresponding one of tripod shafts of an inner member; rolling elements rollably provided between an inner peripheral surface of the outer roller and an outer peripheral surface of the inner roller; an annular spacer in contact with an end surface of each of the rolling elements; and a snap ring fitted to the outer roller and configured to restrict axial displacement of the inner roller and the spacer. The rolling elements are rollably supported in the axial direction by the annular spacer in contact with the end surfaces of the rolling elements.

### INCORPORATION BY REFERENCE

The disclosure of Japanese Patent Application No. 2016-023713 filed on Feb. 10, 2016 including the specification, drawings and abstract is incorporated herein by reference in its entirety.

### BACKGROUND

1. Technical Field

The disclosure relates to a roller unit for a sliding-type tripod constant-velocity joint, and relates also to a sliding-type tripod constant-velocity joint.

2. Description of Related Art

A sliding-type tripod constant-velocity joint normally includes a tubular outer ring having three raceway grooves, a tripod provided with three tripod shafts extending in the radial direction of the tripod, and double-roller-type roller units rotatably supported on the respective tripod shafts. Each of the roller units includes an outer roller, an inner roller, rolling elements, such as needles, and snap rings. The outer roller of each roller unit is rollable on a corresponding one of the raceway grooves of the outer ring. The inner roller of each roller unit is rotatably supported on an outer peripheral surface of a corresponding one of the tripod shafts. The rolling elements are rollably interposed between the outer roller and the inner roller. The snap rings are fitted to the outer roller to restrict the axial displacement of the inner roller and the rolling elements. See, for example, Japanese Patent Application Publication No. 2011-163411 (JP 2011-163411 A).

Such a roller unit is assembled in the following manner. First, a snap ring is fitted into an annular groove provided in one end portion of an outer roller. Next, rolling elements are provided on an inner peripheral surface of the outer roller along the entire circumference thereof, such that one end of each rolling element comes into contact with the snap ring fitted to the outer roller. An inner roller is provided inward of the rolling elements in the radial direction of the roller unit, such that an end surface of one end portion of the inner roller also comes into contact with the snap ring. Finally, another snap ring is fitted into an annular groove provided in the inner peripheral surface of the other end portion of the outer roller. See, for example, Japanese Patent Application Publication No. 2007-177958 (JP 2007-177958 A).

In related art, during the assembly of a roller unit for a sliding-type tripod constant-velocity joint, in order to fit a snap ring having an opening to an outer roller, the snap ring is inserted into an annular groove of the outer roller with the diameter of the snap ring reduced. Then, the diameter of the snap ring is increased using a restoring force due to the elasticity of the snap ring, whereby the snap ring is fitted into the annular groove serving as a fitting groove.

### SUMMARY

Structurally, a snap ring in the related art inevitably has a clearance at its opening. As a result, for example, when an outer roller rotates relative to an inner roller during an operation of a constant-velocity joint, rolling elements that are guided with their ends kept in contact with the snap ring may be caught in or fall into the clearance at the opening of the snap ring. As a result, rolling of the rolling elements or rotation of the outer roller may be hindered, or abnormal contact between the rollers and the rolling elements may occur, leading to a reduction in the durability.

The disclosure provides a roller unit for a sliding-type tripod constant-velocity joint, the roller unit configured to enhance the durability without hindering rolling of rolling elements.

A first aspect of the disclosure relates to a roller unit for a sliding-type tripod constant-velocity joint. The sliding-type tripod constant-velocity joint includes an outer member, an inner member, and the roller unit. The outer member has a tubular shape, and is coupled to a first shaft. The outer member has three raceway grooves provided in an inner peripheral surface of the outer member, and the three raceway grooves extend in a tube axial direction of the outer member. The inner member is provided inside the outer member, and is coupled to a second shaft. The inner member includes a boss portion and tripod shafts, the boss portion has an annular shape, the boss portion is coupled to the second shaft, the tripod shafts each extend outward in a radial direction of the boss portion, the tripod shafts each are inserted into a corresponding one of the three raceway grooves. The roller unit is provided between the outer member and the inner member. The roller unit includes an outer roller, an inner roller, rolling elements, a spacer, and a snap ring. The outer roller is rollably provided in a corresponding one of three the raceway grooves. The inner roller is rotatably supported on a corresponding one of the tripod shafts of the inner member. The rolling elements are rollably provided between an inner peripheral surface of the outer roller and an outer peripheral surface of the inner roller. The spacer has an annular shape, and is in contact with an end surface of each of the rolling elements. The snap ring is fitted to the outer roller, and is configured to restrict axial displacement of the inner roller and the spacer.

With the above configuration, the rolling elements are rollably supported in the axial direction by the annular spacer in contact with the end surfaces of the rolling elements. Thus, the rolling elements are prevented from being caught in or falling into a clearance at an opening of the snap ring. This reduces the possibility that rolling of the rolling elements or rotation of the outer roller will be hindered, or abnormal contact between the rollers and the rolling elements will occur and the durability will be reduced.

In addition, it is no longer necessary to take into account the possibility that the rolling elements will be caught in or fall into a clearance at an opening of the snap ring. Therefore, the need to strictly perform dimensional tolerance management of the opening of the snap ring can be reduced, leading to a cost reduction. Further, an allowable clearance can be increased due to the reduction in the need to strictly perform the dimensional tolerance management. This facilitates the fitting of the snap ring, thereby improving the efficiency of assembling the roller unit.

In the roller unit described above, the outer roller may include a flange provided on the inner peripheral surface of one axial end portion of the outer roller, and the outer roller may have a fitting groove provided in the inner peripheral surface of the other axial end portion of the outer roller. The flange may protrude inward in a radial direction of the outer roller, and the flange may be configured to restrict axial displacement of the inner roller and the rolling elements. The snap ring may be configured such that axial displacement of the inner roller, the spacer, and the rolling elements are restricted when the snap ring is fitted into the fitting groove.

The roller unit may be configured such that the snap ring and the spacer are provided at only the other end portion. With this configuration, the number of components of the roller unit is reduced as a whole and the configuration of the roller unit is simplified.

A second aspect of the disclosure relates to a sliding-type tripod constant-velocity joint. The sliding-type tripod constant-velocity joint includes an outer member, an inner member, and roller units. The outer member has a tubular shape, and is coupled to a first shaft. The outer member has three raceway grooves provided in an inner peripheral surface of the outer member, and the three raceway grooves extend in a tube axial direction of the outer member. The inner member is provided inside the outer member, and is coupled to a second shaft. The inner member includes a boss portion and tripod shafts, the boss portion has an annular shape, the boss portion is coupled to the second shaft, the tripod shafts each extend outward in a radial direction of the boss portion, the tripod shafts each is inserted into a corresponding one of the three raceway grooves. The roller unit is provided between the outer member and the inner member. The roller unit includes an outer roller, an inner roller, rolling elements, a spacer, and a snap ring. The outer roller is rollably provided in a corresponding one of the three raceway grooves. The inner roller is rotatably supported on a corresponding one of the tripod shafts of the inner member. The rolling elements are rollably provided between an inner peripheral surface of the outer roller and an outer peripheral surface of the inner roller. The spacer has an annular shape, and is in contact with an end surface of each of the rolling elements. The snap ring is fitted to the outer roller, and is configured to restrict axial displacement of the inner roller and the spacer.

With the above configuration, the rolling elements are rollably supported in the axial direction by the annular spacer in contact with the end surfaces of the rolling elements. Thus, the rolling elements are prevented from being caught in or falling into a clearance at an opening of the snap ring. This reduces the possibility that rolling of the rolling elements or rotation of the outer roller will be hindered, or abnormal contact between the rollers and the rolling elements will occur and the durability will be reduced.

In addition, it is no longer necessary to take into account the possibility that the rolling elements will be caught in or fall into a clearance at an opening of the snap ring. Therefore, the need to strictly perform dimensional tolerance management of the opening of the snap ring can be reduced, leading to a cost reduction. Further, an allowable clearance can be increased due to the reduction in the need to strictly perform the dimensional tolerance management. This facilitates the fitting of the snap ring, thereby improving the efficiency of assembling the roller unit.

In the sliding-type tripod constant-velocity joint described above, the outer roller may include a flange provided on the inner peripheral surface of one axial end portion of the outer roller, and the outer roller may have a fitting groove provided in the inner peripheral surface of the other axial end portion of the outer roller. The flange may protrude inward in a radial direction of the outer roller, and the flange may be configured to restrict axial displacement of the inner roller and the rolling elements. The snap ring may be configured such that axial displacement of the inner roller, the spacer, and the rolling elements are restricted when the snap ring is fitted into the fitting groove.

The sliding-type tripod constant-velocity joint may be configured such that the snap ring and the spacer are provided at only the other end portion of the outer roller. With this configuration, the number of components of the roller unit is reduced as a whole and the configuration of the roller unit is simplified.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a sectional view illustrating an example of a drive shaft assembly provided with a constant-velocity joint according to the disclosure;

FIG. 2 is an enlarged sectional view illustrating a portion II in FIG. 1;

FIG. 3 is an enlarged sectional view illustrating a portion III in FIG. 2;

FIG. 4 is a plan view as viewed from the direction of an arrow IV in FIG. 2;

FIG. 5 is a plan view illustrating an example of a spacer in an embodiment of the disclosure; and

FIG. 6 is a sectional view illustrating a roller unit in another embodiment of the disclosure.

### DETAILED DESCRIPTION OF EMBODIMENTS

Hereinafter, a roller unit for a sliding-type tripod constant-velocity joint according to an embodiment of the disclosure will be described with reference to the accompanying drawings.

Here, description will be provided on an example case in which a sliding-type tripod constant-velocity joint provided with a roller unit according to the present embodiment is used for coupling of, for example, a power transmission shaft (hereinafter, referred to as “drive shaft”) of a vehicle.

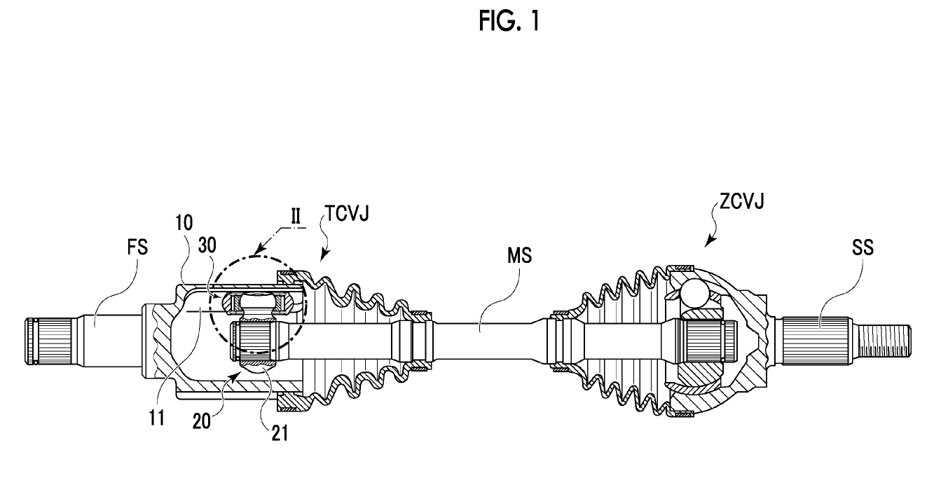

In the example, a drive shaft assembly illustrated in FIG. 1 is provided at a front side portion of a front-engine front-wheel-drive (FF) vehicle. In the example, a sliding-type tripod constant-velocity joint (TCVJ) is provided at a site of coupling between a first shaft FS coupled to, for example, a differential gear and an intermediate shaft MS. In the example, a Rzeppa constant-velocity joint (ZCVJ) is provided at a site of coupling between the intermediate shaft MS and a second shaft SS provided on the wheel side.

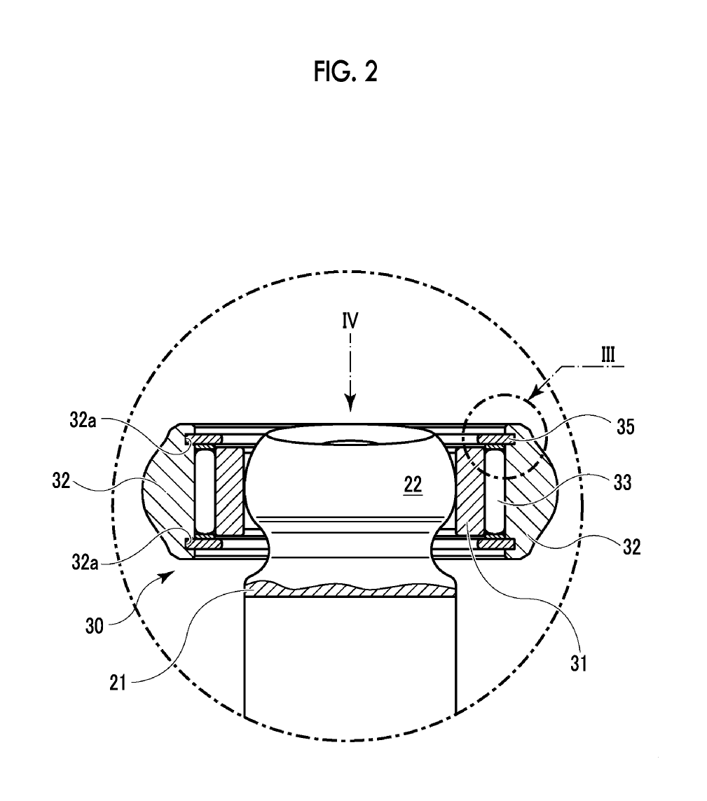

The tripod constant-velocity joint (TCVJ) will be described with reference to FIG. 1 and FIG. 2. FIG. 2 is an enlarged view of a portion II in FIG. 1. The tripod constant-velocity joint TCVJ includes, as main components, an outer member 10, an inner member 20, and roller units 30. The outer member 10 is coupled to a shaft provided on one side (the first shaft FS in FIG. 1), and the inner member 20 is coupled to a shaft provided on the other side (the intermediate shaft MS in FIG. 1). The roller units 30 are interposed between the outer member 10 and the inner member 20.

The outer member 10 is a bottomed tubular member. The outer member 10 is coupled at its tube bottom side to the first shaft FS. Three raceway grooves 11 are provided in an inner peripheral surface of a tubular portion of the outer member 10 at regular intervals in the circumferential direction of the outer member 10. The raceway grooves 11 extend in the tube axial direction (the shaft axial direction: the right-left direction in FIG. 1). Note that only one raceway groove 11 is illustrated in FIG. 1.

The inner member 20 is provided inside the tubular portion of the outer member 10. The inner member 20 includes a boss portion 21 having an annular shape and coupled to the intermediate shaft MS via splines, and three tripod shafts 22 extending radially outward from an outer periphery of the boss portion 21, which is formed in a generally spherical convex shape. Each of the tripod shafts 22 has a pillar shape, and is inserted into a corresponding one of the raceway grooves 11 of the outer member 10.

To be specific, as illustrated in FIG. 2, a part of an outer peripheral surface of each tripod shaft 22 has a spherical convex shape set such that a middle portion of the tripod shaft 22 in its axial direction (the pillar direction of the tripod shaft 22) bulges, by a largest amount, outward in the radial direction of the tripod shaft 22. That is, a root portion of each tripod shaft 22 has a constricted shape. The tripod shafts 22 are provided at regular intervals (intervals of 120°) in the circumferential direction of the boss portion 21. At least a distal end portion of each tripod shaft 22 is inserted into a corresponding one of the raceway grooves 11 of the outer member 10.

The overall shape of each roller unit 30 is a cylindrical shape. The roller unit 30 is rotatably and oscillatably provided on the outer peripheral side of the tripod shaft 22, and is rollably provided in the raceway groove 11. Each roller unit 30 includes an inner roller 31, an outer roller 32, needles 33 that serve as a plurality of rolling elements, two spacers 34, and two snap rings 35.

Each inner roller 31 has a cylindrical shape, and is rotatably and oscillatably supported on a corresponding one of the tripod shafts 22. Each outer roller 32 also has a cylindrical shape. An outer peripheral surface of the outer roller 32 has a shape that conforms to the raceway groove 11. Thus, the outer roller 32 is engaged with the raceway groove 11 so as to be rollable about an axis extending in the up-down direction in FIG. 2.

Further, fitting grooves 32a having an annular shape and having a prescribed depth are provided in an inner peripheral surface of the outer roller 32. In the inner peripheral surface of the outer roller 32, one of the fitting grooves 32a is provided in an outer region (an upper region in FIG. 2) in the radial direction of the inner member 20, and the other one of the fitting grooves 32a is provided in an inner region (a lower region in FIG. 2) in the radial direction of the inner member 20. The separation distance between the fitting grooves 32a provided at these two respective positions is substantially equal to the tube length of the inner roller 31, and is also substantially equal to a value obtained by adding the thicknesses of the two spacers 34 to the axial length of each needle 33 (described later). Each needle 33 is in the form of an elongate column with spherical both end portions. The needles 33 are interposed between the inner roller 31 and the outer roller 32 so as to be rollable relative to the inner roller 31 and the outer roller 32.

In the present embodiment, even when an angle is formed between the intermediate shaft MS and the first shaft FS, a rotary driving force is transmitted at a constant velocity between the intermediate shaft MS and the first shaft FS because the inner member 20 and the roller units 30 are interposed between the intermediate shaft MS and the first shaft FS.

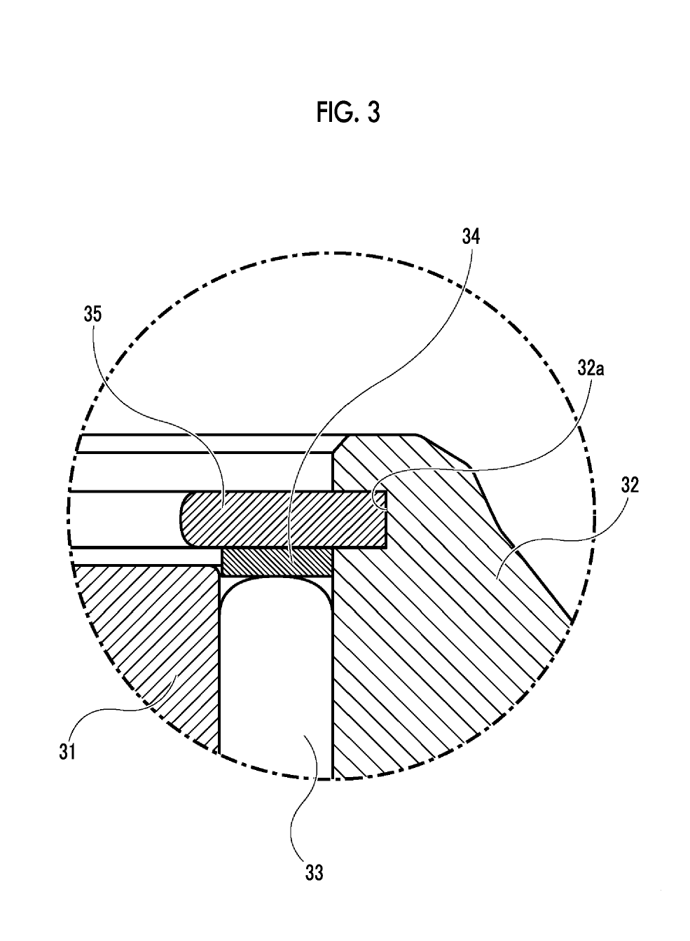

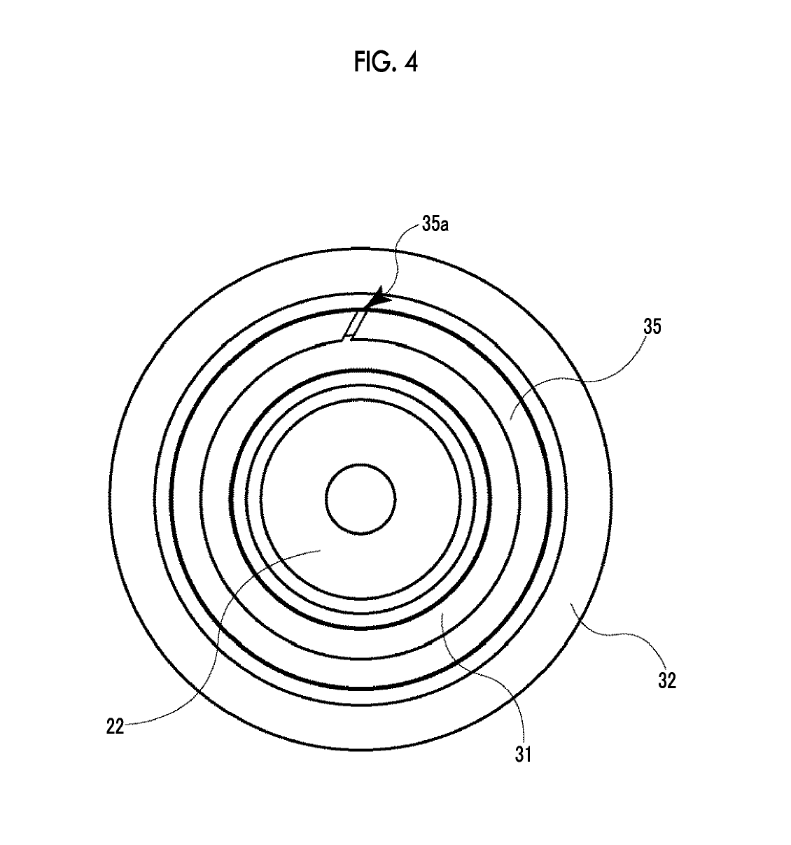

As illustrated in FIG. 4, each snap ring 35 is a C-shaped retaining ring having an opening 35a. That is, each snap ring 35 is in such a shape that the diameter thereof can be reduced. The snap rings 35 are fitted into the respective fitting grooves 32a having an annular shape. The snap rings 35 are then engaged with the inner roller 31 and the spacers 34 in the axial direction of the roller unit 30 (in the up-down direction in FIG. 2 and FIG. 3). That is, the snap rings 35 are members for preventing the inner roller 31 and the spacers 34 from coming out of the inside of the outer roller 32 upward and downward in FIG. 2.

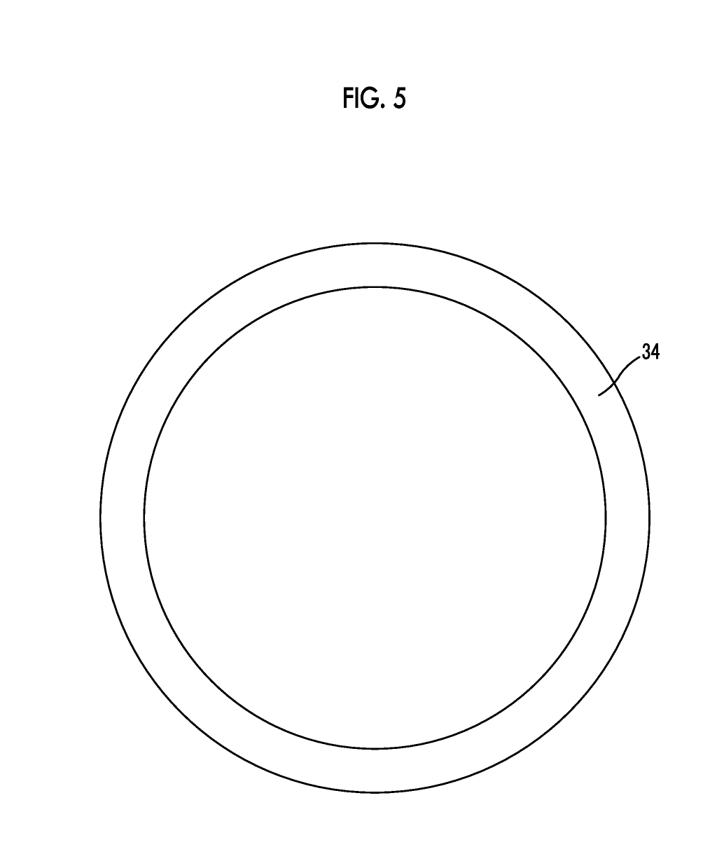

As illustrated in FIG. 5, each spacer 34 according to the present embodiment is an annular member having flat upper and lower surfaces. The outer diameter of each spacer 34 is substantially equal to the inner diameter of the outer roller 32, and the inner diameter of each spacer 34 is substantially equal to the outer diameter of the inner roller 31.

The assembly of each roller unit 30 in the foregoing embodiment will be described below. First, one of the snap rings 35 is fitted into the fitting groove 32a provided in one end portion of the outer roller 32. Next, one of the spacers 34 is provided on the snap ring 35 fitted in the fitting groove 32a. Then, the needles 33 are provided on the inner peripheral surface of the outer roller 32 along the entire circumference thereof, such that one end of each needle 33 comes into contact with the spacer 34. The inner roller 31 is provided inward of the needles 33 in the radial direction of the roller unit 30, such that an end surface of one end portion of the inner roller 31 comes into contact with the snap ring 35. Further, the other one of the spacers 34 is provided between an inner peripheral portion of the outer roller 32 and an outer peripheral portion of the inner roller 31, such that the other one of the spacers 34 comes into contact with the other end of each needle 33. Finally, the other one of the snap rings 35 is fitted into the fitting groove 32a provided in the inner peripheral surface of the other end portion of the outer roller 32.

In the sliding-type tripod constant-velocity joint, each roller unit 30 is assembled such that the spacers 34 are interposed between the ends of the needles 33 and the snap rings 35. With this configuration, for example, even when the roller unit 30 oscillates relative to the tripod shaft 22 and the needles 33 turn around the inner roller 31 while rotating about their axes between the inner roller 31 and the outer roller 32, the spherical end surfaces of the needles 33 can smoothly roll on the flat surfaces of the spacers 34. Thus, the end portions of the needles 33 are reliably prevented from being caught in or falling into the openings 35a of the snap rings 35.

In the foregoing embodiment, the fitting grooves 32a are provided in the respective end portions of the inner peripheral surface of the outer roller 32 in the up-down direction, and the snap rings 35 are fitted into the respective fitting grooves 32a to hold the spacers 34. However, as another embodiment, a fitting groove 32a may be provided in only one of an upper portion and a lower portion of the outer roller 32, and a flange 32b may be provided at the other one of the upper portion and the lower portion of the outer roller 32.

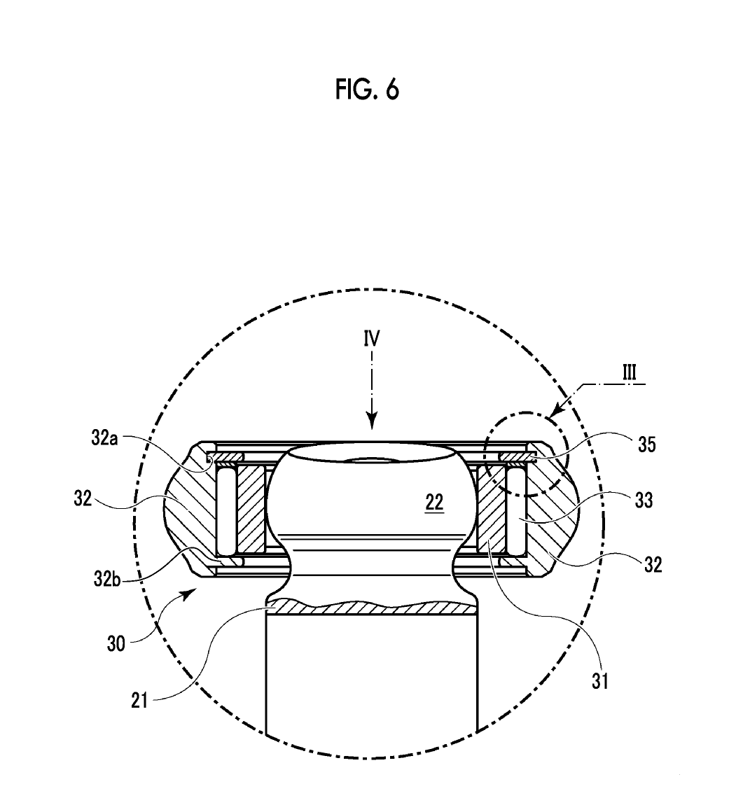

That is, in the present embodiment, as illustrated in FIG. 6, the outer roller 32 is provided with the flange 32b protruding from the inner peripheral surface of one end portion thereof inward in the radial direction of the outer roller 32. Thus, in the roller unit, the axial displacement of the inner roller 31 and the needles 33 is restricted by the flange 32b substituting for the spacer and the snap ring at the one end portion of the outer roller 32. On the other hand, at the other end portion of the outer roller 32, the snap ring 35 is fitted into the fitting groove 32a provided in the inner peripheral surface of the outer roller 32 to restrict the axial displacement of the inner roller 31, the spacer, and the needles 33, as in the foregoing embodiment. That is, the roller unit is configured such that the snap ring 35 and the spacer are provided at only the other end portion. With this configuration, the number of components of the roller unit is reduced as a whole and the configuration of the roller unit is simplified.

In each of the roller units for a sliding-type tripod constant-velocity joint, the end surfaces of the needles are supported on the annular surface of the spacer, which is flat along the entire circumference thereof, and thus the end portions of the needles are reliably prevented from being caught in or falling into the opening of the snap ring. Therefore, the need to strictly perform dimensional tolerance management of the opening of the snap ring can be reduced, leading to a reduction of cost of the snap ring itself. Further, an allowable clearance can be increased due to the reduction in the need to strictly perform the dimensional tolerance management. This facilitates the fitting of the snap ring, thereby improving the efficiency of assembling the roller unit.

What is claimed is:

1. A roller unit for a sliding-type tripod constant-velocity joint,
the sliding-type tripod constant-velocity joint including
an outer member having a tubular shape, the outer member being coupled to a first shaft,
the outer member having three raceway grooves provided in an inner peripheral surface of the outer member, and the three raceway grooves extending in a tube axial direction of the outer member, and
an inner member provided inside the outer member, the inner member being coupled to a second shaft, the inner member including a boss portion and tripod shafts, the boss portion having an annular shape, the boss portion being coupled to the second shaft, the tripod shafts each extending outward in a radial direction of the boss portion, and the tripod shafts each being inserted into a corresponding one of the three raceway grooves, and
the roller unit provided between the outer member and the inner member,
the roller unit comprising:
an outer roller rollably provided in a corresponding one of the three raceway grooves;
an inner roller rotatably supported on a corresponding one of the tripod shafts of the inner member;
rolling elements rollably provided between an inner peripheral surface of the outer roller and an outer peripheral surface of the inner roller;
a spacer having an annular shape, and the spacer being in contact with an end surface of each of the rolling elements; and
a snap ring fitted to the outer roller, and the snap ring being configured to restrict axial displacement of the inner roller and the spacer.

2. The roller unit according to claim 1, wherein
the outer roller includes a flange provided on the inner peripheral surface of one axial end portion of the outer roller, and the outer roller has a fitting groove provided in the inner peripheral surface of the other axial end portion of the outer roller,
the flange protrudes inward in a radial direction of the outer roller, and the flange is configured to restrict axial displacement of the inner roller and the rolling elements, and
the snap ring is configured such that axial displacement of the inner roller, the spacer, and the rolling elements are restricted when the snap ring is fitted into the fitting groove.

3. A sliding-type tripod constant-velocity joint comprising:
an outer member having a tubular shape, the outer member being coupled to a first shaft, the outer member having three raceway grooves provided in an inner peripheral surface of the outer member, and the three raceway grooves extending in a tube axial direction of the outer member;
an inner member provided inside the outer member, the inner member being coupled to a second shaft, the inner member including a boss portion and tripod shafts, the boss portion having an annular shape, the boss portion being coupled to the second shaft, the tripod shafts each extending outward in a radial direction of the boss portion, and the tripod shafts each being inserted into a corresponding one of the three raceway grooves; and
roller units provided between the outer member and the inner member, each of the roller units including
an outer roller rollably provided in a corresponding one of the three raceway grooves,
an inner roller rotatably supported on a corresponding one of the tripod shafts of the inner member,
rolling elements rollably provided between an inner peripheral surface of the outer roller and an outer peripheral surface of the inner roller,
a spacer having an annular shape, and the spacer being in contact with an end surface of each of the rolling elements, and
a snap ring fitted to the outer roller, and the snap ring being configured to restrict axial displacement of the inner roller and the spacer.

4. The sliding-type tripod constant-velocity joint according to claim 3, wherein
the outer roller includes a flange provided on the inner peripheral surface of one axial end portion of the outer roller, and the outer roller has a fitting groove provided in the inner peripheral surface of the other axial end portion of the outer roller,
the flange protrudes inward in a radial direction of the outer roller, and the flange is configured to restrict axial displacement of the inner roller and the rolling elements, and
the snap ring is configured such that axial displacement of the inner roller, the spacer, and the rolling elements are restricted when the snap ring is fitted into the fitting groove.
